(19) United States
(12) Patent Application Publication
(10) Pub. No.: US 2011/0131623 A1
(43) Pub. Date: Jun. 2, 2011

(54) SYSTEM FOR PROVIDING MOBILE CONTENTS USING SETTOP BOX ON IPTV NETWORK AND METHOD THEREOF

(75) Inventors: Shin-Yuk KANG, Daejeon (KR); Tae-In Hwang, Daejeon (KR); Moon-Ok Choi, Cheongju-si (KR); Jong-Youl Park, Daejeon (KR); Jin-Young Moon, Daejeon (KR); Eui-Hyun Paik, Daejeon (KR)

(73) Assignee: Electronics and Telecommunications Research Institute, Daejeon (KR)

(21) Appl. No.: 12/881,410

(22) Filed: Sep. 14, 2010

(30) Foreign Application Priority Data
Nov. 30, 2009 (KR) 10-2009-0117330

(51) Int. Cl. H04N 7/173

(52) U.S. Cl. 725/110

(57) ABSTRACT

A settop box based on an IPTV according to an embodiment of the present invention includes: a home network interface communicating with one or more mobile terminals; a terminal profile manager acquiring and managing a terminal profile from a mobile terminal connected through the home network interface; a contents converter converting contents received from an external contents server through an external network to mobile contents suitable for the corresponding mobile terminal on the basis of the acquired terminal profile; a contents storage storing the contents converted by the contents converter; and a transmitting/receiving controller performing a processing operation to extract the mobile contents stored in the contents storage and transmit the extracted mobile contents to the mobile terminal through the home network interface in accordance with a request from a user.

### CROSS REFERENCE TO RELATED APPLICATIONS

This application claims priority to Korean Patent Application No. 10-2009-0117330 filed on Nov. 30, 2009, the entire contents of which are herein incorporated by reference.

### BACKGROUND OF THE INVENTION

1. Field of the Invention

The present invention relates to a system for providing mobile contents using a settop box based on an IPTV network and a method thereof. More particularly, the present invention relates to a system for converting contents received from an external contents server to mobile contents and providing the converted mobile contents to a mobile terminal accessing a home network and a method thereof.

2. Description of the Related Art

With rapid development of a broadcasting technology, a broadcasting environment is diversified and in recent years, an Internet protocol television (IPTV) technology based on Internet has been developed and compatibilized.

The IPTV technology provides a bidirectional television broadcasting service through high-speed Internet. By connecting a contents server with a display apparatus via a settop box interfacing between the Internet and the display apparatus (i.e., TV), the contents server provides an information contents service, a moving picture contents service, a broadcasting contents service, etc., to a user through the display apparatus connected to the settop box. Therefore, the user watches a real-time broadcasting stream transmitted from the contents server by using the settop box or receives a requested VOD from the contents server and watches the received VOD through the TV.

However, by considering the use of a general settop box, it is difficult to use contents through another apparatus except for the TV connected to the settop box.

By considering a current home network environment, various digital apparatuses are connected through a wireless LAN or connected through a short-range wireless protocol such as Bluetooth, and a wireless USB. Demands of users for watching contents provided from an external contents server to an IPTV settop box are always provided through other apparatuses except for the TV connected to the home network under such an environment. Moreover, demands to watch contents transmitted through the settop box are generated through various mobile terminals under a mobile environment.

### SUMMARY OF THE INVENTION

In order to solve the above-mentioned problems, there is an object of the present invention to provide a method for solving limitation of a contents providing area having a known settop box to the TV. Many homes have already configured the home network through the wireless LAN and mobile terminals also have one or more network interfaces (Bluetooth, wireless LAN, etc.). Therefore, a hardware base for solving the problem is sufficient.

Accordingly, there is another object of the present invention to construct a ubiquitous environment by receiving various contents stored in a settop box by allowing users to easily access the home network through various mobile terminals and to enjoy various contents provided from the settop box under various mobile environments.

According to an aspect of the present invention, there is provided a settop box based on an IPTV that includes: a home network interface communicating with one or more mobile terminals; a terminal profile manager acquiring and managing a terminal profile from a mobile terminal connected through the home network interface; a contents converter converting contents received from an external contents server through an external network to mobile contents suitable for the corresponding mobile terminal on the basis of the acquired terminal profile; a contents storage storing the contents converted by the contents converter; and a transmitting/receiving controller performing a processing operation to extract the mobile contents stored in the contents storage and transmit the extracted mobile contents to the mobile terminal through the home network interface in accordance with a request from a user.

In particular, the home network interface communicates with the mobile terminal by using any one communication protocol among Bluetooth, a wireless USB, infrared communication, an RFID, Zigbee, a UWB, and a wireless LAN.

Further, the settop box further includes a mobile terminal authentication unit authenticating the mobile terminal connected through the home network interface.

In addition, the terminal profile includes a screen resolution of the mobile terminal and video codec information supported by the mobile terminal.

Meanwhile, according to another aspect of the present invention, there is provided a mobile terminal receiving mobile contents from a settop box based on an IPTV that includes: a home network interface communicating with the settop box; a profile manager transmitting a terminal profile of the mobile terminal to the settop box through the home network interface; a mobile contents storage receiving and storing converted mobile contents on the basis of the terminal profile from the settop box; and a contents manager performing a processing operation to extract the mobile contents stored in the mobile contents storage and output the extracted mobile contents through a display means in accordance with a request from a user.

In particular, the home network interface communicates with the mobile terminal by using any one communication protocol among Bluetooth, a wireless USB, infrared communication, an RFID, Zigbee, a UWB, and a wireless LAN.

Further, the terminal profile includes a screen resolution of the mobile terminal and video codec information supported by the mobile terminal.

In addition, the mobile terminal further includes an authentication processor requesting authentication of the mobile terminal to the settop box.

Meanwhile, according to yet another aspect of the present invention, there is provided a method for providing mobile contents in a settop box based on an IPTV that includes: receiving an authentication request from a mobile terminal connected through a home network; authenticating the mobile terminal in accordance with the authentication request; requesting a terminal profile to the authenticated mobile terminal; receiving and storing the terminal profile from the mobile terminal; determining whether or not a request for the mobile contents is received from the mobile terminal; determining whether or not the corresponding mobile contents are stored when the request for the mobile contents is received from the mobile terminal; and extracting the corresponding mobile contents and transmitting the contents to the mobile terminal when the corresponding mobile contents are stored.

In particular, the method for providing mobile contents in a settop box further includes: requesting the corresponding contents to a contents server when the corresponding mobile contents are not stored; and receiving the corresponding contents from the contents server, and converting the received contents to mobile contents suitable for the mobile terminal on the basis of the terminal profile and transmitting the converted mobile contents to the mobile terminal.

Further, the terminal profile includes a screen resolution of the mobile terminal and video codec information supported by the mobile terminal.

According to an embodiment of the present invention, the following effects can be expected.

A user can receive various contents stored in a settop box by accessing a home network through his/her own mobile terminal.

Accordingly, the user can watch desired contents through various mobile terminals connected to the home network by deviating from just watching the contents only through a TV connected to an IPTV settop box. As a result, continuity of providing the contents in the home network can be ensured.

### BRIEF DESCRIPTION OF THE DRAWINGS

FIG. 1 is an exemplified diagram for describing a mobile contents providing system using an IPTV settop box according to an embodiment of the present invention;

FIG. 2 is a diagram for describing configurations and functions of a settop box and a mobile terminal of FIG. 1 in detail; and

FIG. 3 is a flowchart for describing a mobile contents providing method using an IPTV settop box according to an embodiment of the present invention.

### DETAILED DESCRIPTION OF THE PREFERRED EMBODIMENTS

Hereinafter, the present invention will be described in detail with reference to the accompanying drawings. Herein, the detailed description of a related known function or configuration that may make the purpose of the present invention unnecessarily ambiguous in describing the present invention will be omitted. Exemplary embodiments of the present invention are provided so that those skilled in the art may more completely understand the present invention. Accordingly, the shape, the size, etc., of elements in the figures may be exaggerated for explicit comprehension.

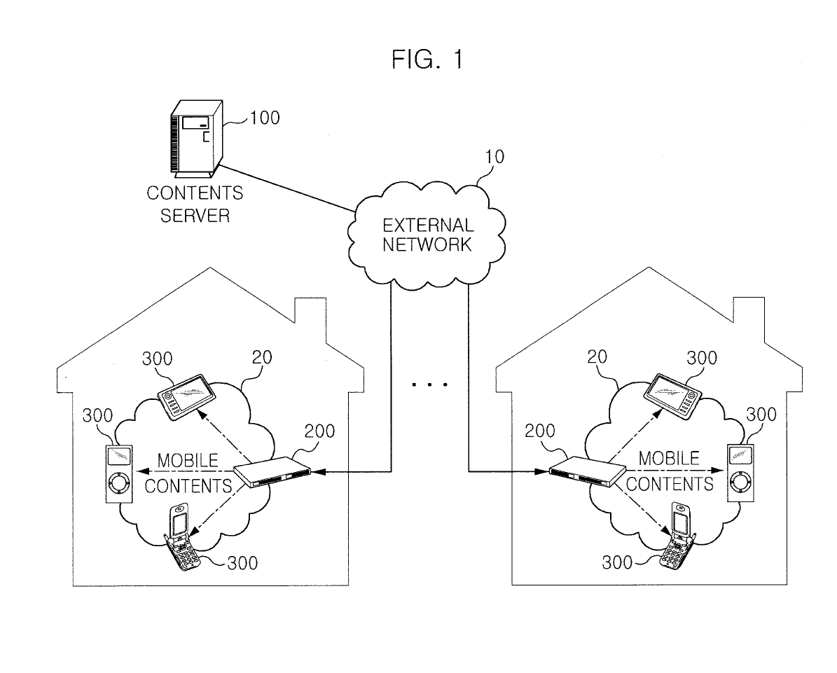

FIG. 1 is an exemplified diagram for describing a mobile contents providing system using an IPTV settop box according to an embodiment of the present invention.

The mobile contents providing system according to the embodiment of the present invention includes a contents server 100, a settop box 200, and a mobile terminal 300.

The contents server 100, as a web server, provides information contents, moving picture contents, broadcasting contents, etc., to the settop box 200 through an external network 10. In particular, a contents group in which a plurality of contents form one group for a movie, a drama, series, etc., may exist in the contents.

The settop box 200 accesses the contents server 100 through the external network 10 to request contents selected by a user to the contents server 100 and output the contents transmitted in accordance with the request through a display apparatus (not shown). Herein, the display apparatus may correspond to a TV.

In particular, the settop box 200 authenticates the mobile terminal 300 through the home network 20. In addition, after converting the contents received from the contents server 100 into the mobile contents and storing the converted mobile contents on the basis of a terminal profile acquired from the authenticated mobile terminal 300, the settop box 200 extracts and provides the corresponding mobile contents to the mobile terminals 300 connected to the home network 20 in accordance with a request from the user.

According to the embodiment of the present invention, the user can receive various contents stored in the settop box 200 by easily accessing the home network 20 through various mobile terminals 300.

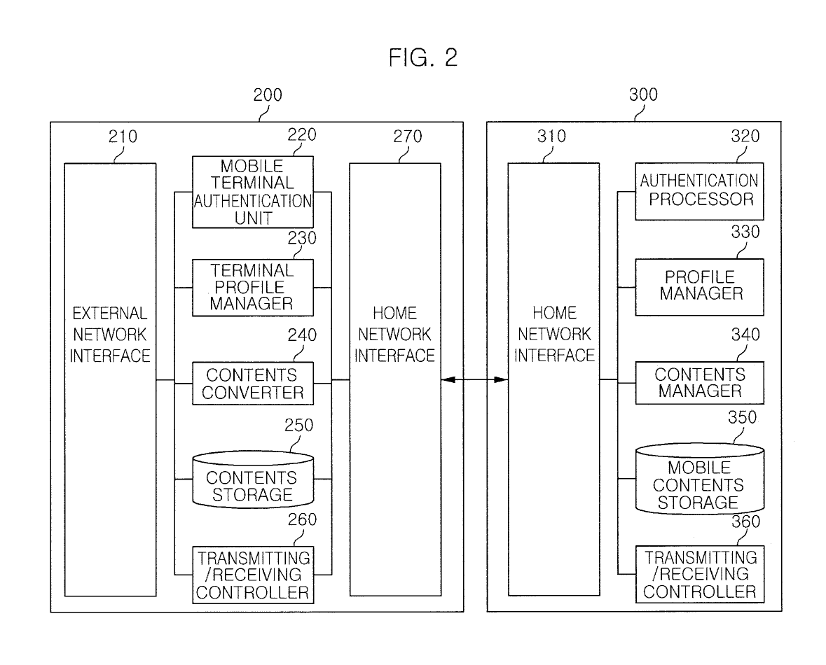

FIG. 2 is a diagram for describing configurations and functions of a settop box 200 and a mobile terminal 300 of FIG. 1 in detail.

Referring to FIG. 2, first, the settop box 200 according to the embodiment of the present invention includes an external network interface 210, a mobile terminal authentication unit 220, a terminal profile manager 230, a contents converter 240, a contents storage 250, a transmitting/receiving controller 260, and a home network interface 270.

The external network interface 210 communicates with the contents server through an external network (Internet network), and requests the contents selected by the user to the contents server and receives the contents transmitted in accordance with the request.

The mobile terminal authentication unit 220 serves to authenticate the mobile terminal 200 connected through the home network interface. authentication in the mobile terminal authentication unit 220 is performed in accordance with a predetermined procedure defined in a communication protocol with the mobile terminal 200 and may be performed through various known terminal authentication methods.

The terminal profile manager 230 acquires the terminal profile from the mobile terminal 200 connected through the home network interface and manages it. Herein, the terminal profile includes screen resolution (e.g., WVGA 800*480) of the mobile terminal 300 and video codec information (e.g., mpeg-4 codec) supported by the mobile terminal 200.

The contents converter 240 converts contents received from an external contents server through the external network into mobile contents suitable for the mobile terminal 300 on the basis of the terminal profile acquired by the terminal profile manager 230.

The contents storage 250 stores the contents converted by the contents converter 240 and provides the converted contents to the transmitting/receiving controller 260 in accordance with a request from the transmitting/receiving controller 260.

The transmitting/receiving controller 260 performs a processing operation to extract the mobile contents stored in the contents storage 250 and transmit the extracted mobile contents to the mobile terminal 300 through the home network interface 270 in accordance with a request from the user.

The home network interface 270 communicates with one or more mobile terminals by using a short-range wireless communication technology. in this case, the home network interface 270 communicates with the mobile terminal 300 by using any one communication protocol among Bluetooth, a wireless universal serial bus (USB), infrared communication (infrared data association (IrDA)), Zigbee, an ultra wideband (UWB), and a wireless LAN.

Meanwhile, in the case in which the settop box 200 can convert the contents received from the contents server in real time, an additional storing means is not required. However, conversion to a codec having high compression rate may apply a large load to the settop box 200. Therefore, it is preferable that the converted contents are stored in an additional storing means and provided to the mobile terminal 300 in the settop box 200.

In addition, the mobile terminal 300 according to the embodiment of the present invention includes components corresponding to functions of the above-mentioned settop box 200 and interoperates with the settop box 200 through the components.

More specifically, the mobile terminal 300 includes a home network interface 310, an authentication processor 320, a profile manager 330, a contents manager 340, a mobile contents storage 350, and a transmitting/receiving controller 360.

The home network interface 310 communicates with the settop box 200 by using the short-range wireless communication technology. As described above, the home network interface 310 communicates with the settop box 200 by using any one communication protocol among the Bluetooth, the wireless universal serial bus (USB), the infrared communication (infrared data association (IrDA)), the Zigbee, the ultra wideband (UWB), and the wireless LAN.

The authentication processor 320 requests authentication of the mobile terminal 300 to the mobile terminal authentication unit 220 of the settop box 200 and processes the authentication in accordance with the predetermined procedure defined in the communication protocol with the settop box 200.

The profile manager 330 transmits the terminal profile of the mobile terminal 300 to the terminal profile manager 230 of the settop box 200 through the home network interface 310. The terminal profile which the profile manager 330 of the mobile terminal 300 transmits to the terminal profile manager 230 of the settop box 200 includes screen resolution of the mobile terminal 300 and video code information supported by the mobile terminal 300.

The mobile contents storage 350 receives and stores the mobile contents converted based on the terminal profile in the settop box 200, from the settop box 200.

The contents manager 340 performs a processing operation to extract the mobile contents stored in the mobile contents storage 350 and transmit the extracted mobile contents through a display means (not shown) in accordance with a request from the user.

In the mobile terminal 300, in the case in which the mobile contents need not to be additionally stored, the received mobile contents may be directly outputted through the display means without performing a storing process.

The transmitting/receiving controller 360 controls a data transmitting/receiving function of the mobile terminal 300.

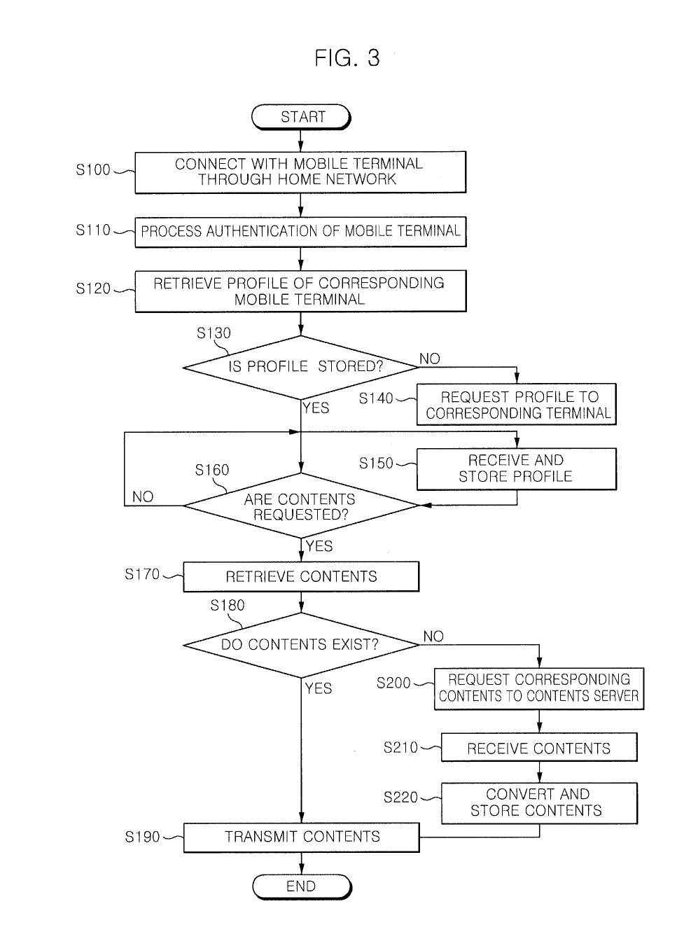

FIG. 3 is a flowchart for describing a mobile contents providing method using an IPTV settop box according to an embodiment of the present invention.

Referring to FIG. 3, first, when the settop box according to the embodiment of the present invention is connected with a mobile terminal through a home network (S100), the settop box receives a mobile terminal authentication request message from the connected mobile terminal. When the authentication request message is received from the mobile terminal, authentication is processed in accordance with a predetermined procedure defined in a communication protocol with the mobile terminal (S110). The authentication includes general processes in various known terminal authentications.

Next, it is retrieved whether or not a terminal profile (hereinafter, referred to as a ‘profile’) of the corresponding mobile terminal is stored (S120 and S130). In the case of a mobile terminal which has ever been connected to the settop box, a profile of the corresponding terminal is stored in a profile manager.

According to the determination result at step S130, when the profile of the corresponding mobile terminal is not stored in the profile manager, the profile is requested to the corresponding mobile terminal (S140) and, as a result, the profile is received from the mobile terminal and stores in the profile manager (S150).

Next, the settop box determines whether or not a request for mobile contents from the mobile terminal connected through the home network (S160).

According to the determination result at step S160, when the request for the mobile contents is received from the mobile terminal, a process of retrieving whether or not the corresponding mobile contents are stored in a contents storage is performed (S170).

According to the retrieval result of the corresponding mobile contents through step S170, when the corresponding mobile contents are stored in the contents storage (S180), the corresponding mobile contents are extracted from the contents storage and the extracted mobile contents are transmitted to the mobile terminal through a real-time streaming scheme or downloading scheme (S190).

However, according to the retrieval result of the corresponding mobile contents through step S170, when the corresponding mobile contents are not stored in the contents storage (S180), the corresponding contents are requested to and received from the contents server and thereafter, the corresponding contents are converted based on the profile of the mobile terminal acquired through step S130 or S150 and the converted contents are stored in the contents storage (S220). In addition, when conversion and storage of the contents are completed, the corresponding contents stored in the contents storage are extracted and transmitted to the mobile terminal through the real-time streaming scheme or downloading scheme in this case, the storage process at step S220 may be omitted depending on the performance of the settop box and the contents may be converted and transmitted in real time.

According to an embodiment of the present invention, since a user can watch desired contents through various mobile terminals connected to a home network by deviating from just watching the contents only through a TV connected to an IPTV settop box, continuity of providing the contents in a home can be ensured.

Some steps of the present invention can be implemented as a computer-readable code in a computer-readable recording medium. The computer-readable recording media includes all types of recording apparatuses in which data that can be read by a computer system is stored. Examples of the computer-readable recording media include a ROM, a RAM, a CD-ROM, a CD-RW, a magnetic tape, a floppy disk, an HDD, an optical disk, an optical data storage, etc., and in addition, include a recording medium implemented in the form of a carrier wave (for example, transmission through the Internet). Further, the computer-readable recording media are distributed on computer systems connected through the network, and thus the computer-readable recording media may be stored and executed as the computer-readable code by a distribution scheme.

As described above, the preferred embodiments have been described and illustrated in the drawings and the description. Herein, specific terms have been used, but are just used for the purpose of describing the present invention and are not used for defining the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. A settop box based an IPTV, comprising:
a home network interface communicating with one or more mobile terminals;
a terminal profile manager acquiring and managing a terminal profile from a mobile terminal connected through the home network interface;
a contents converter converting contents received from an external contents server through an external network to mobile contents suitable for the corresponding mobile terminal on the basis of the acquired terminal profile;
a contents storage storing the contents converted by the contents converter; and
a transmitting/receiving controller performing a processing operation to extract the mobile contents stored in the contents storage in accordance with a request from a user and transmit the extracted mobile contents to the mobile terminal through the home network interface.

2. The settop box according to claim 1, wherein the home network interface communicates with the mobile terminal by using any one communication protocol among Bluetooth, a wireless USB, infrared communication, an RFID, Zigbee, a UWB, and a wireless LAN.

3. The settop box according to claim 1, further comprising a mobile terminal authentication unit authenticating the mobile terminal connected through the home network interface.

4. The settop box according to claim 1, wherein the terminal profile includes a screen resolution of the mobile terminal and video codec information supported by the mobile terminal.

5. A mobile terminal receiving mobile contents from a settop box based on an IPTV, comprising:
a home network interface communicating with the settop box;
a profile manager transmitting a terminal profile of the mobile terminal to the settop box through the home network interface;
a mobile contents storage receiving and storing converted mobile contents on the basis of the terminal profile from the settop box; and
a contents manager performing a processing operation to extract the mobile contents stored in the mobile contents storage and output the extracted mobile contents through a display means in accordance with a request from a user.

6. The mobile terminal according to claim 5, wherein the home network interface communicates with the settop box by using any one communication protocol among Bluetooth, a wireless USB, infrared communication, an RFID, Zigbee, a UWB, and a wireless LAN.

7. The mobile terminal according to claim 5, wherein the terminal profile includes a screen resolution of the mobile terminal and video codec information supported by the mobile terminal.

8. The mobile terminal according to claim 5, further comprising an authentication processor requesting authentication of the mobile terminal to the settop box.

9. A method for providing mobile contents in a settop box based on an IPTV, comprising:
receiving an authentication request from a mobile terminal connected through a home network;
authenticating the mobile terminal in accordance with the authentication request;
requesting a terminal profile to the authenticated mobile terminal;
receiving and storing the terminal profile from the mobile terminal;
determining whether or not a request for the mobile contents is received from the mobile terminal;
determining whether or not the corresponding mobile contents are stored when the request for the mobile contents is received from the mobile terminal; and
extracting the corresponding mobile contents and transmitting the contents to the mobile terminal when the corresponding mobile contents are stored.

10. The method for providing mobile contents in a settop box according to claim 9, further comprising:
requesting the corresponding contents to a contents server when the corresponding mobile contents are not stored; and
receiving the corresponding contents from the contents server, and converting the received contents to mobile contents suitable for the mobile terminal on the basis of the terminal profile and transmitting the converted mobile contents to the mobile terminal.

11. The method for providing mobile contents in a settop box according to claim 9, wherein the terminal profile includes a screen resolution of the mobile terminal and video codec information supported by the mobile terminal.
